(19) United States
(12) Patent Application Publication
(10) Pub. No.: US 2026/0280339 A1
(43) Pub. Date: Sep. 17, 2026

(54) Optimum Utilization of Electric Circuit Capacity by Adding Electric Vehicle Charging

(71) Applicant: NETZERO V2G TECHNOLOGIES LLC, Fort Washington, PA (US)

(72) Inventor: Paul Harriman KYDD, Lawrenceville, NJ (US)

(73) Assignee: NETZERO V2G TECHNOLOGIES LLC, Fort Washington, PA (US)

(21) Appl. No.: 19/667,515

(22) Filed: May 4, 2026

Related U.S. Application Data
(63) Continuation of application No. 17/248,576, filed on Jan. 29, 2021, now Pat. No. 12,640,586.

(51) Int. Cl. H02J 13/13; B60L 53/30; G05B 15/02; G06Q 30/04; G06Q 50/06; H02J 13/12

(52) U.S. Cl. CPC H02J 13/1335; B60L 53/30; G05B 15/02; G06Q 30/04; G06Q 50/06; H02J 13/12

(57) ABSTRACT

This invention enables Electric Vehicle (EV) charging requirements to be supplied by electric power available off-peak without increasing demand charges. It does this by continually measuring primary loads and enabling EV charging to utilize only that power that will not increase total demand. Grouping software available from Electric Vehicle Service Equipment (EVSE) suppliers allows the available power to be shared among multiple vehicles.

### CROSS-REFERENCE TO RELATED APPLICATIONS

The present application is a continuation of U.S. patent application Ser. No. 17/248,576 filed on Jan. 29, 2021 and titled Optimum Utilization of Electric Circuit Capacity by Adding Electric Vehicle Charging the disclosures of which are incorporated herein by reference in their entirety.

This application is related to U.S. patent application “Vehicle-Solar-Grid Integration” Ser. No. 14/101423 filed Dec. 10, 2013, now issued as U.S. Pat. No. 9,566,867, Feb. 14, 2017, by the present inventor, and Provisional Patent Applications “Bidirectional Power Electronic Interface” No. 61/889,067, filed Oct. 10, 2013, “Bidirectional Power Electronic Interface with Sustaining Power” 61/921,583, filed Dec. 30, 2013, “Vehicle-Solar-Grid Integration with Supplementary Battery” 62/050,819, filed Sep. 16, 2014, “Low-Cost EVPV for Vehicle-Solar-Grid Integration” 62/297,462, filed Feb. 19, 2016, “Minimum Cost EVPV for Vehicle-Solar-Grid Integration” 62/299,756, filed Feb. 25, 2016, later filed as non provisional patent application Ser. No. 15/441,484, Feb. 24, 2017, now issued as U.S. Pat. No. 10,439,428, Oct. 8, 2019, and a companion filing “Method of Using Minimum Cost EVPV for Vehicle-Solar-Grid Integration” Ser. No. 16/562,565, Sep. 3, 2019, “Vehicle-Solar-Grid Integration for Back up Power” 62/465,424 filed Mar. 1, 2017 now filed as non provisional patent application Ser. No., Ser. No. 16/044,683, application Ser. No. “Non Grid-Tied Vehicle-Solar Uninterruptable Power System” 62/544,041, filed Aug. 11, 2017, now filed as patent application Ser. No. 16/055,035, and “Demand Charge Management by Electric Vehicles”, 62/721,216, filed Aug. 22, 2018, and now filed as non provisional patent application Ser. No. 16/563,108, “Minimum Cost Demand Charge Management by Electric Vehicles”, “Electric Vehicle Service Equipment Adapter Module to Control Added Loads”, Ser. No. 16/580,663 Sep. 24, 2019, by the present inventor, and “Multiple Load Micro-Grid Implementation of Vehicle-Solar-Grid Integration”62/320,701, filed Apr. 11, 2016, by the present inventor and Brian R. Hamilton of Cranbury, N.J., and Chris A. Martin of Media, Pa.

I claim priority for this invention by virtue of provisional patent application “Optimum Utilization of Circuit Capacity by Adding Electric Vehicle Charging” filed on Feb. 19, 2020, Application No. 62/978,381.

### FEDERALLY SPONSORED RESEARCH

None

### CITED LITERATURE

“SAE J-1772 Standard for Electric Vehicle Charging Equipment”, Revised, October, 2012.

U.S. Pat. Nos. 10,333,307, and 10,333,306, Hooshmand, and U.S. Patent Applications 2019-0369166, Moslemi, 2019-0148945, 2019-0147552, Nakayama, 2019-0140465, 2019-0137956, 2019-0131923, Hooshmand, and 2019-0056541, 2019-0036341, 2018-0090935, Ashgari, all assigned to NEC.

U.S. Pat. No. 9,5520,623 Honma, assigned to Panasonic

2019-0079473 Kumar, 2019-0206000, ELBsat assigned to Johnson controls

2018-0018007 and U.S. Pat. No. 10,126,796, Doorn, assigned to Accenture

2016-0211676 and U.S. Pat. No. 10,186,865, Chiang, assigned to Aver Information

2016-0006245, and U.S. Pat. No. 9,948,101, Chow, 2014-0067140, Gow, assigned to Green Charge Networks, U.S. Pat. No. 10,140,670, Gow, assigned to Energie Storage Services.

### FIELD OF THE INVENTION

The present disclosure describes a system and method for electric vehicle charging that allows vehicles to be recharged without incurring added demand charges from an electric energy supplier. It is a system for increasing the utilization of electric circuitry both behind the meter, and more particularly to electric vehicle charging that is controlled to minimize demands on the electric grid.

### BACKGROUND OF THE INVENTION

Electric Vehicles (EVs) with their very large storage batteries ranging in capacity from 16 to over 60 kiloWatt hours (kWh) represent a major new load on the electric energy supply grid that can be a source of needed revenue to the electric utilities and a very economical source of energy for personal transportation. Uncontrolled, however, this load can be a major problem. If every EV plugs in and begins to recharge at 5 PM, it can aggravate the peak load on the entire electric grid system from generation through transmission to distribution, resulting in high-cost energy due to high wholesale prices, and increased demand charges by the distribution companies. But this problem can be controlled due to the flexibility of EV charging. Because it doesn't matter when the EV is charged, as long as it is ready to go the next day, it is possible to allow the EV driver to plug in at 5 PM, but delay the actual charging until the early morning hours when electric energy is available and inexpensive, and when excess transmission and distribution capacity are available.

Managed charging is enabled by the communication functions of the Internet and the wireless telephone infrastructure underlying the “Internet of Things”. Individual devices can be aggregated and controlled via the Internet “cloud” providing data handling and reporting functions. The devices in this case are Electric Vehicle Service Equipments (EVSEs) which link the electric power available from the grid, typically as 240 V, single-phase, Alternating Current (AC) in residences, to the on-board charger on the EV via a flexible cable and plug. The design and operating details of the EVSE and plug are specified in SAE Standard J-1772.

There is an opportunity to increase the efficiency with which electric circuitry is utilized still further by grouping EVSEs together while limiting the amount of power (in kiloWatts, kW) that the group can draw. Grouping is a feature that several EVSE manufacturers offer. It operates by networking a specified group of EVSEs over the Internet so that cloud-resident software can limit the amount of power drawn by the group to a specified amount, and distribute this amount evenly to the EVSEs in the group.

For example if a street lighting transformer has a rating of 25 kiloVolt-Amps, kVA and a normal load of 12 kVA at night, it can power a group of two 10 kW EVSEs with a limiting amount of 13 kVA. It can support the lights and a single EVSE at full power at night. If another vehicle plugs in, the two vehicles share the 13 kVA limit at 6.5 kW each. During the day, when the lights are off, both EVSEs can draw their full 10 kW.

It would be desirable if the grouping system could measure the actual draw for the primary use and adjust the limit on the group accordingly. For example, in the morning as the lights turn off, one by one under photocell control, the amount of power available for EV charging could be increased continuously providing the maximum in EV charging power and optimizing the utilization of the relevant circuitry without overloading it. That is the objective of this invention.

This invention can serve to improve circuit utilization in many situations beyond the street lighting example recited above. As Electric Vehicles become common, demand for recharging facilities will increase, representing a major investment requirement unless they can be serviced efficiently with existing wiring. Any increase in electric demand due to EV charging will bring with it increased demand charges from the local electric energy distribution company. It is another objective of this invention to provide for the installation of EVSEs using excess off-peak capacity of existing circuitry to service the additional load without requiring additional capacity or increased demand charges.

### BRIEF SUMMARY OF THE INVENTION

The objectives of this invention are achieved by a system having the ability to measure the primary load on a metered circuit and to control a group of EVSEs to utilize as much power as will not exceed the monthly demand charge limit for the primary load. The system comprises a meter on the primary circuit input and a controller with a microcomputer running software that can limit the total load including the group of EVSEs to the expected monthly demand charge limit. The controller does this by outputting a limit signal to cloud-resident grouping software that can control the operation of the EVSEs.

This invention is particularly applicable to circuits with limited capability such as the street lighting example cited above. Also to metered circuits in residential and commercial buildings where it is desired to offer EV charging without upgrading electric supply capacity or increasing demand charges.

### BRIEF DESCRIPTION OF THE DRAWINGS

FIG. 1 is a schematic diagram showing the system of this invention applied to a building with a metered electric energy supply and added EVSEs.

FIG. 2 is a schematic diagram of software used by the system of FIG. 1 to achieve continuous evaluation of the amount or power available for EV charging and of the expected demand charge limit.

### DETAILED DESCRIPTION OF THE INVENTION: THE PREFERRED EMBODIMENT

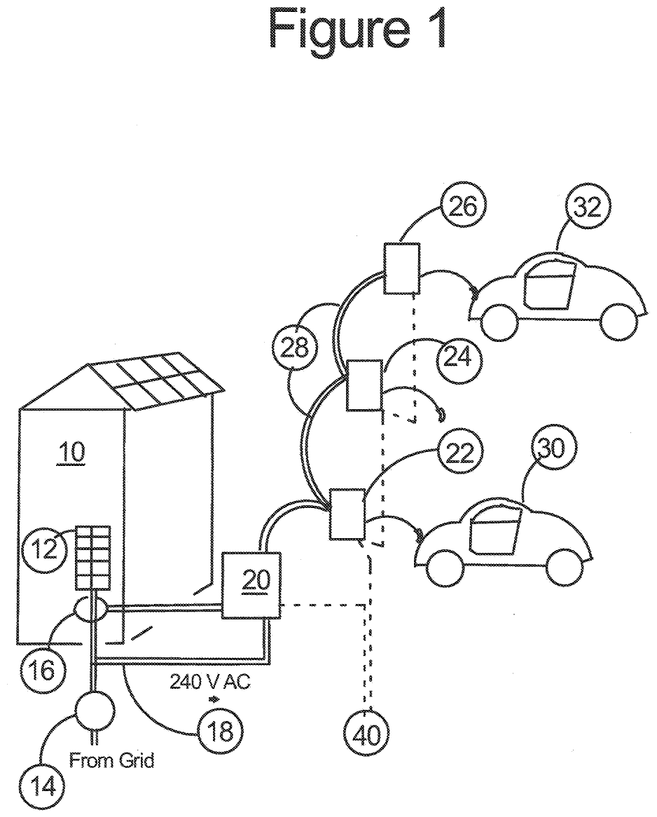

FIG. 1 shows a building 10 with electric distribution panel 12 supplied with electric energy from the electric grid through meter 14. EVSEs 22, 24 and 26 are grouped on circuit 28, which is controlled by the system controller 20 of this invention.

Controller 20 reads current transformer 16 deployed between meter 14 and circuit panel 12 to measure the primary load on the circuit. Tap 18 prior to transformer 16 provides electric power to group 28, which is not measured by current transformer 16. Controller 20 comprises a microcomputer to run software to control charging in accord with this invention and communication equipment to communicate with WiFi router or cellphone connection to the Internet 40, which also communicates with EVSEs 22, 24 and 26. Electric vehicles 30 and 32 are plugged in to EVSEs 22 and 26 waiting for controller 20 to enable charging by transmitting an available power limit signal through router 40 to the cloud which will return charging signals distributing the available power equally to 30 and 32.

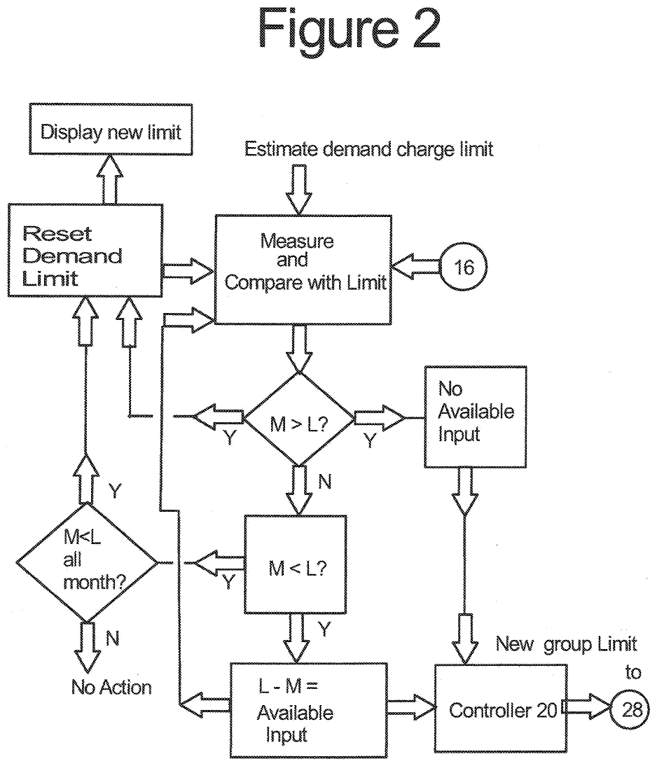

FIG. 2 is a schematic diagram of the software in controller 20, which controls EVSE group 28 and recalculates from month to month the demand charge limit. The program is started with an estimate of the demand charge limit L derived from previous month's electric bills. This is an estimated maximum demand for the primary loads of the building, which determine the demand charge leveled by the electric distribution company. As long as the demand measured by current transformer 16, M, is lower that the estimated demand charge limit, controller 20 sets the limit for the group of EVSEs at the difference between the measured primary demand M and the demand charge limit L. The EVSE cloud-based grouping software then splits up the available EVSE power A=L-M between EVs 30 and 32 which are plugged in ready to charge. In the early morning hours with low primary demand and few EVs plugged in they may be able to draw maximum power without increasing demand. At other times with more EVs or less power available above the primary needs, the group of EVSEs will share the available power, but in all cases the circuit will be providing the maximum power that can be used at the limiting power that is available and thus at minimum cost. The result is an increase in the efficiency of utilization of electric energy supply based on the ability of EVs to accept energy at variable rates and variable times without prejudicing the utility of the vehicles.

Controller 20 measures the demand for primary loads at suitable intervals such as the 15 minutes often used for demand charging. If the measured primary load is greater than the estimated limit, M>L, the limit will need to be reset upwards because next month's bill will show a higher demand. Also there is no room for EV charging and a signal to that effect is sent to Group 28.

If M is not greater than L, L<M, two actions are taken. First, the actual M readings are stored in a register for a monthly billing period and if all M for the month are lower than L the highest M for the month is the new (lower) L for the next month.

Second, L-M is the available power for EV charging, which is transmitted by controller 20 to group 28 as the new group limit. The EVSE group utilizes this available power to recharge the EVs in the most efficient manner. If there is enough power available and few enough EVs connected the EVs will be charged at maximum power. If there are more EVs or less power, the available power will be apportioned among the EVs by the EVSE supplier over the internet as they are programmed to do by the EVSE manufacturer. The program then recycles to the next measurement M and comparison of M and L.

### EXAMPLE

Starting with the configuration shown in FIG. 1 at midnight with an estimated demand charge limit L of 50 kW and a measured primary load M of 25 kW there is 25 kW of capacity to charge the two EVs connected, and each can charge at the maximum rating of the EVSEs of 10 kW. The total load, primary plus EVs, is 45 kW.

At 6 AM the primary load has risen to 35 kW and the controller 20 has signaled to the cloud-based grouping software controlling EVSE group 28 that the group limit is now down to 15 kW. The grouping software splits this between the two EVs and allows each to charge at 7.5 kW. The total load is 50 kW.

At noon the primary load is 40 kW and the group limit is 10 kW. If only one EV wants to charge it gets the full 10 kW. The total load is 50 kW.

At 6 PM the primary load is 50 kW, the group limit is zero and even though two EVs are back and plugged in, the EV group load is limited to zero, but the total load is 50 kW. The EVs will have to wait until the primary load drops enough to make some capacity available to them. However, they can readily do this since in the early morning hours they can accumulate as much as 60 kWh each, which will take them up to 240 miles each next day.

From this example one can see that although the primary load varies from 25 to 50 kW, a typical range from night to day, by means of this invention and the ability to manage group charging provided by the EVSE manufacturers, the overall load including EVs is almost constant but the demand charge is not increased. The cost of the extra 300 kWh of energy available to recharge the vehicles is just the cost of energy, and the minimum off-peak cost at that.

### Relevant Previous Literature

There are a great many US Patents and Patent Applications on the use of electric energy storage to manage peaks in demand and control demand charges. A number of inventors, Hooshmand, Moshlemi, Nakayama, Ashgari have assigned such patents to NEC, Princeton, N.J., USA. They are primarily concerned with the method of calculating the amount of offsetting power needed from a storage system to control demand charges.

Chiang describes managing charging strips so that the ones most in need are charged first and all are charged adequately, similar to group charging of Electric Vehicles.

Gow calculates a cost of energy and adds energy from storage if warranted.

Doorn allocates EVs to locations where grid power is most available.

Chow measures energy consumed by primary loads and calculates an offset from storage to minimize demand charges.

None of the above disclose a system for measuring the demand of primary loads and filling in the gap with a tailored load which is the essence of this invention. While the drawings and descriptions in this application are intended to be comprehensive, it will be understood by those skilled in the art that there are similar means to achieve the same ends, which fall within the claimed scope of this invention.

1. A method of electric vehicle charging comprising:
deploying a current sensor adjacent a primary load;
supplying electric energy from an electric grid to said primary load;
sensing a current supplied to said primary load through said current sensor;
providing a controller;
reading said current sensor with said controller to measure said primary load on said electric grid and produce a measurement of said primary load;
providing a tap prior to said current sensor;
coupling a group circuit to said tap;
providing electric power to said group circuit from said electric grid without said electric power being measured by said current sensor;
providing a demand charge limit;
when said demand charge limit exceeds said measured primary load, operating said controller to set an available power limit for said group circuit to a difference between said demand charge limit and said measured primary load;
producing an available power limit signal based on said available power limit;
controlling said electric vehicle charging to provide maximum power that can be used for said electric vehicle charging to said group circuit without exceeding said demand charge limit.

2. A method of electric vehicle charging as defined in claim 1 wherein said controlling said electric vehicle charging to provide maximum power that can be used for said electric vehicle charging to said group circuit without exceeding said demand charge limit comprises:
transmitting said available power limit signal from said controller through the cloud to a cloud-based electric vehicle service equipment EVSE grouping software; and
splitting up said electric power provided from said grid to said group circuit between one or more electric vehicles which are plugged in and ready to charge.

3. A method of electric vehicle charging as defined in claim 2 comprising controlling a plurality of EVSE's from said cloud-based EVSE grouping software.

4. A method of electric vehicle charging as defined in claim 3 wherein said controlling said plurality of EVSE's from said cloud-based EVSE grouping software comprises sending a signal from said cloud-based software to an EVSE group.

5. A method of electric vehicle charging as defined in claim 1, wherein said current sensor comprises a current transformer.

6. A method of electric vehicle charging as defined in claim 1, further comprising disposing a circuit panel between said current sensor and said primary load.

7. A method of electric vehicle charging as defined in claim 1 wherein said supplying energy from the electric grid to said primary load further comprises supplying said electric energy through a meter.

8. A method of electric vehicle charging as defined in claim 1 wherein said controller includes a microcomputer running software.

9. A method of electric vehicle charging as defined in claim 1 further comprising providing a Wi-Fi router.

10. A method of electric vehicle charging as defined in claim 1 further comprising providing a cell phone connection to the Internet.

11. A method of electric vehicle charging as defined in claim 1 wherein said electric vehicle charging comprises charging a single electric vehicle.

12. A method of electric vehicle charging as defined in claim 1 wherein said electric vehicle charging comprises charging a group of electric vehicles.

13. A method of electric vehicle charging as defined in claim 1 comprising using an estimated maximum demand to establish a demand charge limit.

14. A method of electric vehicle charging as defined in claim 13 wherein said estimated maximum demand is derived from a previous electric bill.

15. A method of electric vehicle charging as defined in claim 13 wherein said maximum demand is derived from a plurality of previous electric bills.

16. A method of electric vehicle charging as defined in claim 1 further comprising resetting upward said demand charge limit if said measurement of said primary load exceeds said demand charge limit.

17. A method of electric vehicle charging as defined in claim 1 further comprising repeating said reading said current sensor with said controller to measure said primary load on said electric grid and produce a measurement of said primary load at a plurality of regular time intervals to produce a respective plurality of measurements of said primary load.

18. A method of electric vehicle charging as defined in claim 17 further comprising storing said plurality of measurements of said primary load for a billing period and, if every measurement of said plurality of measurements is less than said demand charge limit, resetting said demand charge limit down to a maximum value of said plurality of measurements.

19. A method of electric vehicle charging as defined in claim 18 wherein said storing said plurality of measurements of said primary load for a billing period comprises storing said plurality of measurements in a register.

20. A method of electric vehicle charging as defined in claim 17 wherein said plurality of regular time intervals includes a regular time interval of at least about 15 minutes.

21. A method of electric vehicle charging comprising:
deploying a current sensor adjacent a primary load;
supplying electric energy from an electric grid to said primary load;
sensing a current supplied to said primary load through said current sensor;
providing a controller;
reading said current sensor with said controller to produce a measurement of primary load power of said primary load;
providing a tap between said electric grid and said current sensor;
coupling a group circuit to said tap;
providing electric power to said group circuit from said electric grid through said tap without said electric power being measured by said current sensor;
providing a demand charge limit;
during a time interval when said measured primary load power is less than said demand charge limit, operating said controller to set an available power limit for said group circuit to a difference between said demand charge limit and said measured primary load power;
producing an available power limit signal based on said available power limit;
controlling said electric vehicle charging to provide maximum power that can be used for said electric vehicle charging to said group circuit without exceeding said demand charge limit;
transmitting said available power limit signal from said controller through a Wi-Fi router and the cloud to a cloud-based Electric Vehicle Service Equipment (EVSE) grouping software;
transmitting a signal from said cloud-based EVSE grouping software to an EVSE group including a plurality of Electric Vehicle Service Equipments (EVSE's); and
apportioning said electric power provided from said grid to said group circuit between one or more Electric Vehicles (EVs) which are plugged into said EVSE's of said EVSE group respectively.
